(19) United States
(12) Patent Application Publication
(10) Pub. No.: US 2020/0058419 A1
(43) Pub. Date: Feb. 20, 2020

(54) SUPERCONDUCTIVE WIRE, SUPERCONDUCTIVE COIL AND SUPERCONDUCTIVE CABLE CONDUCTOR

(71) Applicant: Sumitomo Electric Industries, Ltd., Osaka-shi, Osaka (JP)

(72) Inventors: Tatsuhiko YOSHIHARA, Osaka-shi, Osaka (JP); Yoshihiro HONDA, Osaka-shi, Osaka (JP)

(73) Assignee: Sumitomo Electric Industries, Ltd., Osaka-shi, Osaka (JP)

(21) Appl. No.: 16/486,194

(22) PCT Filed: Mar. 7, 2017
(86) PCT No.: PCT/JP2017/009058

§ 371 Date: Aug. 15, 2019

(51) Int. Cl. H01B 12/06; H01F 6/06; H01B 12/16

(52) U.S. Cl. CPC H01B 12/06; H01B 12/16; H01F 6/06

(57) ABSTRACT

Provided are a superconductive wire and a superconductive coil that have sufficient superconductivity and may be manufactured through a simple manufacturing process. The superconductive wire includes a tape-shaped substrate having a main surface and a superconductive layer provided on the main surface. A critical current flowing through an end portion in the width direction perpendicular to the extending direction of the substrate is larger than a critical current flowing through a central portion in the width direction.

### TECHNICAL FIELD

The present invention relates to a superconductive wire, a superconductive coil and a superconductive cable conductor.

### BACKGROUND ART

Conventionally, Japanese Patent Laying-Open No. 2013-235765 (PTL 1) discloses a superconductive wire. The superconductive wire disclosed in PTL 1 includes a substrate, and a superconductive layer provided on the main surface of the substrate with an intermediate layer interposed therebetween.

### CITATION LIST

### Patent Literature

PTL 1: Japanese Patent Laying-Open No. 2013-235765

### SUMMARY OF INVENTION

A superconductive wire according to an aspect of the present disclosure includes a tape-shaped substrate having a main surface, and a superconductive layer provided on the main surface. A critical current flowing through an end portion in a width direction perpendicular to the extending direction of the substrate is larger than a critical current flowing through a central portion in the width direction.

### BRIEF DESCRIPTION OF DRAWINGS

FIG. 1 is a schematic view illustrating a cross section of a superconductive wire according to a first embodiment of the present invention;

FIG. 2 is a graph illustrating the relationship between the ratio of a critical current to the maximum critical current flowing through the superconductive wire and the ratio of the width of an outer peripheral portion to the distance from the center to an end surface of the superconductive wire;

FIG. 3 is a graph illustrating the distribution of current density in the width direction of the superconductive wire;

FIG. 4 is a schematic view for explaining a method of measuring a critical current flowing through the superconductive wire;

FIG. 5 is a schematic view for explaining a method of manufacturing a superconductive wire;

FIG. 6 is a schematic view for explaining a method of manufacturing a superconductive wire;

FIG. 7 is a schematic view illustrating a cross section of a superconductive wire according to a second embodiment of the present invention;

FIG. 8 is a schematic view for explaining a method of manufacturing a superconductive wire;

FIG. 9 is a schematic view illustrating a cross section perpendicular to the coil axis of a superconductive coil according to an embodiment; and

FIG. 10 is a schematic perspective view illustrating the configuration of a superconductive cable conductor according to an embodiment.

### DETAILED DESCRIPTION

### Problem to be Solved by the Present Disclosure

In the superconductive wire disclosed in PTL 1, in order to transport a large critical current, a thick superconductive layer is formed. In order to efficiently manufacture the thick superconductive layer, there is disclosed a method of manufacturing a superconductive wire in which after an oxide superconductive layer is formed on the substrate, an organic metal compound solution is coated on the oxide superconductive layer and temporarily calcined so as to form a calcined film, and after a plurality of calcined films are formed and laminated, a sintering treatment is performed thereon.

However, the above-mentioned superconductive wire is manufactured by a complicated process of laminating a plurality of calcined films, which increases the manufacturing cost.

In view of the problems of the prior art, the present disclosure provides a superconductive wire, a superconductive coil and a superconductive cable conductor. More specifically, the present disclosure provides a superconductive wire, a superconductive coil and a superconductive cable conductor that have sufficient superconductivity and may be manufactured by a simple manufacturing process.

### Advantageous Effect of the Present Disclosure

The superconductive wire, the superconductive coil and the superconductive cable conductor according to the present disclosure may be manufactured by a simple manufacturing process, and may have sufficient superconductivity.

### DESCRIPTION OF EMBODIMENTS

First, embodiments of the present disclosure will be enumerated hereinafter.

(1) A superconductive wire according to an aspect of the present disclosure includes a tape-shaped substrate having a main surface and a superconductive layer provided on the main surface. The critical current flowing through an end portion in a width direction perpendicular to the extending direction of the substrate is larger than the critical current flowing through a central portion in the width direction.

Usually, a superconductive wire is applied with a current that is smaller than the maximum critical current. In this case, it is an end portion of the superconductive wire in the width direction that is mainly responsible for transporting the current. Thus, the current flowing through the central portion in the width direction of the superconductive wire is smaller than the current flowing through the end portion, and the current density in the central portion is lower than that in the end portion. Based on this finding, by increasing the critical current flowing through the end portion larger than the critical current flowing through the central portion in the width direction of the superconductive layer, it is possible to ensure that a sufficiently large current flows through the end portion that is responsible for transporting the current while reducing the critical current flowing through the central portion smaller than that flowing through the end portion. As specific measures, for example, the thickness of the superconductive layer located at the central portion may be reduced, or some steps in the manufacturing process for forming the superconductive layer located at the central portion may be omitted so as to make the superconductivity of the central portion inferior to that of the end portion. Thus, the central portion which is less important in transporting the current in the superconductive wire may be formed to have the minimum required superconductivity compared with the end portion. Compared to the case where the superconductive wire is manufactured to have uniform superconductivity in the entire width as the end portion of the superconductive wire, it is possible to reduce the manufacturing cost of the superconductive wire while maintaining sufficient superconductivity.

(2) In the superconductive wire, when the distance from the center of the substrate to an end surface of the substrate in the width direction is expressed by a (unit: mm), the central portion is a region with a distance of 0.6a or less from the center, and the end portion is a region with a distance greater than 0.6a and equal to or less than (a−0.1) from the center. The critical current flowing through the end portion is 1.1 times or more and 2.5 times or less as large as the critical current flowing through the central portion.

Thus, as long as the operating current is 80% or less of the critical current, the superconductive wire may be used without any problem. The reason why the central portion is defined as a region with a distance of 0.6a or less from the center in the width direction is to ensure the width of the end portion required to flow the operating current through the entire superconductive wire without any problem. Further, the reason why the end portion is defined as a region with a distance greater than 0.6a and equal to or less than (a−0.1) from the center is to form a boundary between the end portion and the central portion at a position with a distance of 0.6a from the center so as to ensure a sufficient width for the end portion. Furthermore, the reason why the outer periphery of the end portion is defined with a distance of (a−0.1) from the center is that slit machining may be performed on the superconductive wire in a range of 0.1 mm from the end surface of the superconductive wire, which may deteriorate the superconductivity of the superconductive wire so that the current may not flow sufficiently.

The reason why the lower limit of the critical current flowing through the end portion is made 1.1 times as large as the critical current flowing through the central portion is that if the lower limit is less than 1.1 times as large as the critical current flowing through the central portion, it would be difficult for the end portion which is mainly responsible for transporting the current to flow a current larger than that flowing through the central portion. The lower limit of the critical current flowing through the end portion may be made 1.3 times as large as the critical current flowing through the central portion.

The upper limit of the critical current flowing through the end portion is made 2.5 times as large as the critical current flowing through the central portion for the following reasons. If the critical current flowing through the end portion is made larger than the critical current flowing through the central portion, in the other words, if the critical current flowing through the central portion is made 40% or more of the critical current flowing through the end portion, the operating current of the superconductive wire may be made about 50% of the critical current. The upper limit of the critical current flowing through the end portion may be made 1.6 times as large as the critical current flowing through the central portion. Thus, the critical current of the central portion may be made 60% or more of the critical current flowing through the end portion, and the operating current of the superconductive wire may be made about 80% of the critical current.

(3) In the superconductive wire, the superconductive layer located at the central portion includes a portion which has a thickness thinner than the thickness of the superconductive layer located at the end portion. Thus, the critical current distribution between the end portion and the central portion may be adjusted by adjusting the thickness of the superconductive layer.

(4) In the superconductive wire, the superconductive layer located at the center includes a portion which has a lower crystal orientation than the superconductive wire located at the end portion. Thus, the critical current distribution between the end portion and the central portion may be adjusted by adjusting the size and/or the degree of the crystal orientation of the portion which has a lower crystal orientation in the superconductive layer located at the central portion.

(5) A superconductive coil according to an aspect of the present disclosure includes the superconductive wire mentioned above and an insulator. The superconductive wire is wound into a spiral shape with a space reserved between adjacent turns, and the insulator is filled in the space.

(6) A superconductive cable conductor according to an aspect of the present disclosure includes the superconductive wire mentioned above.

Since the superconductive wire is manufactured at a lower cost, the superconductive coil or the superconductive cable conductor including such superconductive wire may be obtained at a lower cost than the conventional one.

### DETAILS OF EMBODIMENTS OF THE PRESENT DISCLOSURE

Hereinafter, embodiments of the present disclosure will be described in detail. In the following drawings, the same or corresponding parts will be denoted by the same reference numerals and the description thereof will not be repeated. Note that the embodiments described below may be arbitrarily combined in any combination.

### First Embodiment

(Configuration of Superconductive Wire)

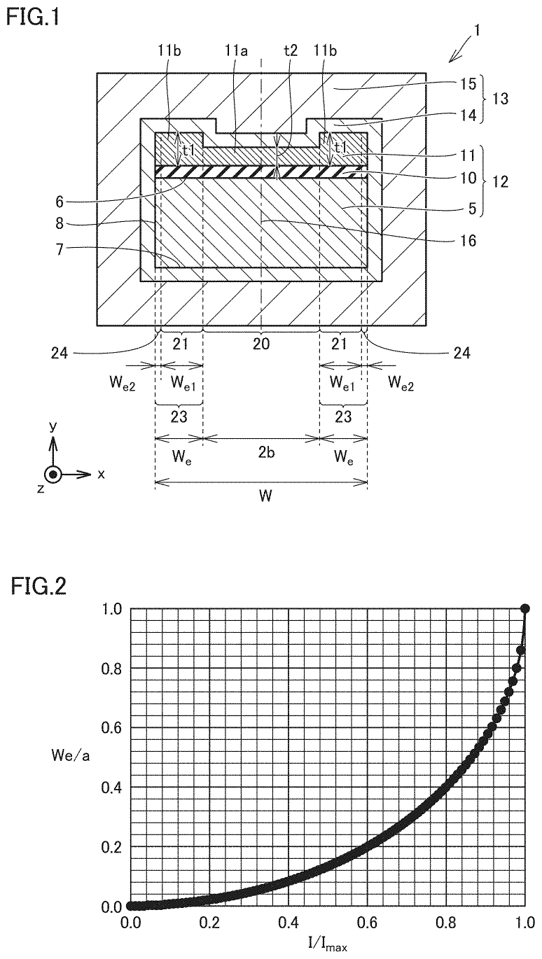

FIG. 1 is a schematic view illustrating a cross section of a superconductive wire 1 according to the present embodiment. The cross section illustrated in FIG. 1 is taken along a direction perpendicular to the longitudinal direction of the tape-shaped superconductive wire. As illustrated in FIG. 1, the superconductive wire 1 according to the present embodiment includes a substrate 5, an intermediate layer 10, a superconductive layer 11, and an enveloping layer 13 as an enveloping conductor layer.

The substrate 5 has a first main surface 6. The superconductive layer 11 is provided on the main surface 6 of the substrate 5 with the intermediate layer 10 interposed therebetween. A critical current flowing through an end portion 21 in the width direction perpendicular to the extending direction of the substrate 5 is larger than a critical current flowing through a central portion 20 in the width direction. In the superconductive wire 1, when the distance from a center 16 in the width direction of the substrate 5 to an end surface of the substrate 5 is expressed by a (unit: mm), the central portion 20 is a region with a distance of 0.6a or less from the center 16, and the end portion 21 is a region with a distance greater than 0.6a and equal to or less than (a−0.1) from the center 16. The critical current flowing through the end portion 21 is 1.1 times or more and 2.5 times or less as large as the critical current flowing through the central portion 20. The upper limit of the critical current flowing through the end portion 21 may be 1.6 times as large as the critical current flowing through the central portion 20. In the superconductive wire 1, a superconductive layer 11a located at the central portion 20 includes a portion which has a thickness t2 thinner than a thickness t1 of a superconductive layer 11b located at the end portion 21.

As illustrated in FIG. 1, the width W of a wire member 12 may be expressed by using the distance a as 2a. The width 2b of the central portion 20 may be expressed by using the distance a as 1.2a. The width Wₑ₁ of the end portion 21 may be expressed by using the distance a as (0.4a−0.1). The width Wₑ₂ of an edge 24 located at the outer periphery of the end portion 21 is, for example, 0.1 mm. The width Wₑ of an outer peripheral portion 23 composed of the end portion 21 and the edge 24 may be expressed by using the distance a as 0.4a.

Preferably, the substrate 5 has a tape shape with a smaller thickness relative to the length in the longitudinal direction. The substrate 5 has a first main surface 6 and a second main surface 7. The second main surface 7 is located opposite to the first main surface 6. The intermediate layer 10 is provided on the first main surface 6.

The substrate 5 may be formed to have a plurality of layers. For example, the substrate 5 may be formed by stacking a first layer, a second layer, a third layer and a fourth layer in the thickness direction of the substrate 5. The first layer is located close to the second main surface 7 and may be made of stainless steel, for example. The second layer may be made of copper (Cu), for example. The third layer may be made of nickel (Ni), for example. The fourth layer may be made of silver (Ag), for example.

The intermediate layer 10 functions as a buffer layer for forming the superconductive layer 11 on the substrate 5. Preferably, the intermediate layer 10 is uniform in crystal orientation. The intermediate layer 10 may be made of a material having a small mismatch in lattice constant with the material constituting the superconductive layer 11. More specifically, the intermediate layer 10 may be made of, for example, cerium oxide (CeO₂) or yttria stabilized zirconia (YSZ).

The superconductive layer 11 is a superconductor containing layer. The material for the superconductive layer 11 is, for example, a rare-earth oxide superconductor. The rare-earth oxide superconductor for the superconductive layer 11 is, for example, REBCO (REBa₂Cu₃O_{y}, RE represents a rare earth element such as yttrium (Y), praseodymium (Pr), neodymium (Nd), samarium (Sm), europium (Eu), gadolinium (Gd)), holmium (Ho) or ytterbium (Yb)). The wire member 12 is constituted by the substrate 5, the intermediate layer 10 and the superconductive layer 11.

The enveloping layer 13 is a layer that envelopes at least the superconductive layer 11. The enveloping layer 13 includes a stabilization layer 14 as a first conductor layer and a protection layer 15 as a second conductor layer. The stabilization layer 14 is formed at least on the superconductive layer 11 and on the second main surface 7 of the substrate 5. The protection layer 15 is formed on the stabilization layer 14. The stabilization layer 14 may be formed on the superconductive layer 11, the second main surface 7 of substrate 5, and a side surface 8 of the superconductive layer 11 and the substrate 5. In other words, the stabilization layer 14 is formed to envelope the outer periphery of the wire member 12.

The stabilization layer 14 protects the superconductive layer 11 by dissipating local heat generated in the superconductive layer 11, and meanwhile acts as a conductor to bypass a current when the superconductive layer 11 is quenched (a phenomenon that a superconductor transits from the superconductive state to the normal conducting state). When the protection layer 15 is formed by plating, for example, the stabilization layer 14 also functions to prevent the superconductive layer 11 from being contacted by the plating liquid during the plating. The material for the stabilization layer 14 may be, for example, silver (Ag).

The stabilization layer 14 may have a single layer structure or a multilayer structure. The stabilization layer 14 may be configured to have any structure as long as it could enhance the adhesion with the superconductive layer 11 and the second main surface 7 of the substrate 5. The stabilization layer 14 may include a layer formed by vapor deposition or sputtering, or may include a layer formed by plating.

The protection layer 15 is formed on the stabilization layer 14. The protection layer 15 is configured to protect the stabilization layer 14 and the wire member 12. Further, the protection layer 15 may act as a conductor to bypass the current when the superconductive layer 11 is quenched. The protection layer 15 is formed to envelope, via the stabilization layer 14, at least a part of the outer periphery of the wire member 12 including the substrate 5 and the superconductive layer 11. In FIG. 1, the protection layer 15 is formed to envelope the entire outer periphery of the wire member 12.

(Effect of Superconductive Wire)

In the superconductive wire 1 illustrated in FIG. 1, the critical current flowing through the end portion 21 in the width direction of the superconductive layer 11 is made larger than the critical current flowing through the central portion 20 by adjusting the thickness t1 and the thickness t2 of the superconductive layer 11. In other words, in order to reduce the critical current flowing through the central portion 20 while ensuring a sufficient current to flow through the end portion 21 that is mainly responsible for transporting current in the superconductive wire 1, the thickness t2 of the superconductive layer 11 located at the central portion 20 is made thinner than the thickness of the superconductive layer 11 located at the end portion 21. Thus, in the superconductive wire 1, the central portion 20 which is less important in transporting the current compared with the end portion 21 may be formed to have the minimum required superconductivity. Compared to the case where the superconductive wire 1 is manufactured to have uniform superconductivity in the entire width as the end portion 21 of the superconductive wire 1, it is possible to reduce the manufacturing cost of the superconductive wire 1 while maintaining sufficient superconductivity.

Thus, by defining the width of the central portion 20 and the width of the end portion 21 as described above, the superconductive wire 1 may be used without any problem when the operating current is 80% or less of the critical current. Furthermore, the critical current distribution between the end portion 21 and the central portion 20 may be adjusted by adjusting the thickness t1 and the thickness t2 of the superconductive layer 11.

(Method for Determining Central Portion and End Portion in Superconductive Wire)

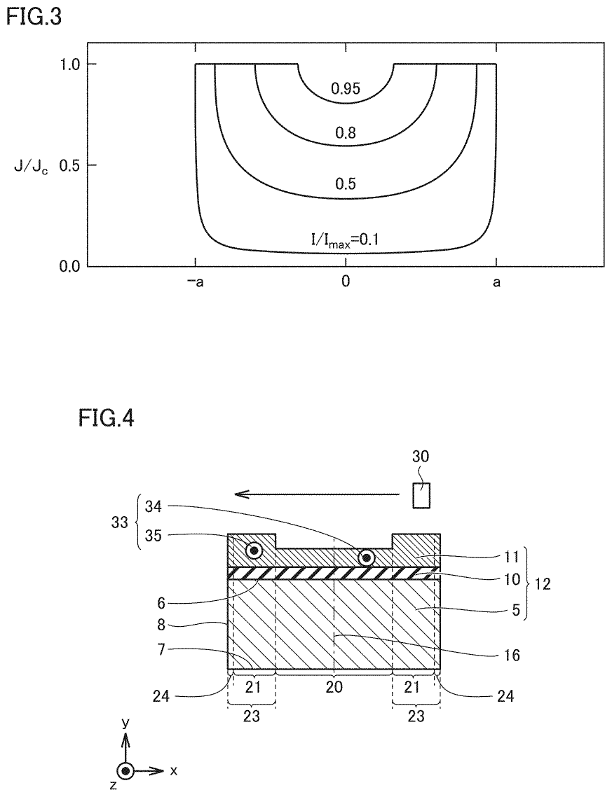

FIG. 2 is a graph illustrating the relationship between the ratio of a current I to the maximum critical current Iₘₐₓ flowing through the superconductive wire 1 and the ratio of the width Wₑ of the outer peripheral portion 23 to the distance a from the center to the end surface of the superconductive wire 1, and FIG. 3 is a graph illustrating the distribution of current density J in the width direction of the superconductive wire 1. A method of determining the central portion 20 and the end portion 21 in the superconductive wire 1 will be described with reference to FIGS. 2 and 3. As reference documents related to the graph illustrated in FIG. 3, a first reference document by M. R., Halse, “AC face field losses in a type II superconductor”, Journal of Physics D: Applied Physics, Vol. 3 (1970) and a second reference document by Ernst Helmut Brandt and Mikhail Indenbom, “Type-II-superconductor strip with current in a perpendicular magnetic field”, Physical Review B, Vol. 48, No. 17, 12893- (1993) may be given. The graph illustrated in FIG. 3 is cited from the second reference document.

When the superconductive wire 1 is conducted in the superconductive state, the current density J of the end portion in the width direction is substantially equal to the critical current density J_{c}, while the current density J of the central portion in the width direction is smaller than the critical current density. Therefore, the distance from the center to the end surface of the superconductive wire in the width direction is expressed by a, and the distance from the center in the width direction to the edge of a region where the current density J is smaller than the critical current density J_{c} is expressed by b. In the present embodiment, since the region where the current density J is smaller than the critical current density J_{c} is the central portion 20, the position with the distance b is the boundary between the central portion 20 and the end portion 21. If the width direction of the superconductive wire is represented by the y axis, the current density J(y) at any position y in the width direction may be expressed by the following equation.

$$\begin{matrix}[ Equation 1 ] & \\ J ( y ) = \{ \begin{matrix}\frac{2 {J}_{c}}{π} {arctan ( \frac{{a}^{2} - {b}^{2}}{{b}^{2} - {y}^{2}} )}^{1 / 2} , & \vert y \vert < b \\ {J}_{c} , & b < \vert y \vert < a .\end{matrix} & ( 1 )\end{matrix}$$

According to the above equation, the total current I flowing through the superconductive wire 1 may be expressed by the following equation.

[Equation 2]

I=2J_{c}(a²−b²)^{1/2},b=a(1−I²/I²ₘₐₓ)^{1/2}, (2)

Based on the above equation, as illustrated in FIG. 2, the relationship between the ratio of the current I to the maximum critical current Iₘₐₓ flowing through the superconductive wire 1 and the ratio of the width Wₑ of the outer peripheral portion 23 to the distance a from the center to the end surface of the superconductive wire 1 may be determined.

In FIG. 2, the horizontal axis indicates I/Iₘₐₓ, and the vertical axis indicates Wₑ/a. As the curve approaches to 1.0 along the vertical axis, it means that the region (the end portion 21) where the current density J is equal to the critical current density J_{c} increases. On the other hand, as the curve approaches to 1.0 along the horizontal axis, it means that the current I flowing through the superconductive wire 1 approaches to the maximum critical current Iₘₐₓ.

Further, as illustrated in FIG. 3, as the value of I/Iₘₐₓ increases, the region where the current density J approaches to the critical current density J_{c} increases from the end surface toward the center in the width direction of the superconductive wire. In FIG. 3, the horizontal axis indicates the width direction of the superconductive wire 1, and the vertical axis indicates the ratio (J/J_{c}) of the current density J to the critical current density J_{c}. FIG. 3 shows the distribution data of J/J_{c} in the width direction when I/Iₘₐₓ is equal to 0.1, 0.5, 0.8 and 0.95, respectively.

From FIG. 2, if the maximum value of the current I during the operation of the superconductive wire 1 is 80% of the maximum critical current Iₘₐₓ, the corresponding value of Wₑ/a is 0.4. In other words, if Wₑ=0.4a or more, the current I during the operation of the superconductive wire 1 is about 80% of the maximum critical current Iₘₐₓ. In this case, the width 2b of the central portion 20 may be expressed as 1.2a. In other words, it is preferable that the central portion 20 is a region with a distance of 0.6a or less from the central 16, and the end portion 21 is a region with a distance greater than 0.6a and equal to or less than (a−0.1) from the center 16. Since the width Wₑ₂ of the edge 24 that would be affected by slit machining or the like is about 0.1 mm, it is preferable to use the region mentioned above that exhibits excellent superconductivity as the end portion 21.

Thus, by making the thickness t2 of the superconductive layer 11 located at the central portion 20 where the current density J is smaller than the critical current density J_{c} thinner than the thickness t1 of the superconductive layer 11 located at the end portion 21 where the current density J is equal to the critical current density J_{c}, it is possible to reduce the amount of material to be used for the superconductive layer 11 located at the central portion 20. However, if it is necessary to increase the operating current I greater than 80% of the maximum critical current Iₘₐₓ, the width b of the central portion 20 may be reduced so as to increase the width Wₑ of the end portion 21.

For example, when the width W of the superconductive wire 1 is equal to 4 mm, the width 2b of the central portion 20 may be made equal to 1.2 mm, the width Wₑ of the outer peripheral portion 23 may be made equal to 0.9 mm, and the width Wₑ₁ of the end portion 21 may be made equal to 0.8 mm. When the width W of the superconductive wire 1 is equal to 30 mm, the width 2 b of the central portion 20 may be made equal to 18 mm, the width Wₑ of the outer peripheral portion 23 may be made equal to 6 mm, and the width Wₑ₁ of the end portion 21 may be made equal to 5.9 mm.

(Method of Measuring Critical Current Distribution in Superconductive Wire)

FIG. 4 is a schematic view for explaining a method of measuring a critical current flowing through the superconductive wire 1. The method of measuring the critical current distribution in the superconductive wire 1 will be described with reference to FIG. 4.

As the method of measuring the critical current distribution in the superconductive wire 1, a self magnetic field method may be used. Specifically, as illustrated in FIG. 4, a current 33 corresponding to the critical current is applied to the superconductive wire. Due to the critical current distribution in the superconductive wire 1, a current 34 flows through the central portion 20, and a current 35 flows through the end portion 21. Then, a detection sensor 30 such as a Hall element is used to measure the distribution of magnetic fields (self magnetic field) generated by the currents 34 and 35. The detection sensor 30 may measure the magnetic field distribution while scanning in the width direction of the superconductive wire 1, for example. The distribution of critical current Ic may be determined from the magnetic field distribution obtained above.

In addition, as a method of measuring the critical current distribution, a method other than the self magnetic field method may be used. For example, when an external magnetic field is applied to the superconductive wire 1, a shielding current with a magnitude corresponding to the critical current distribution in the superconductive wire may flow through the superconductive wire, which may generate a magnetic field that cancels the external magnetic field. Therefore, the critical current distribution may be measured by measuring the magnetic field distribution with a detection sensor such as a Hall element.

Furthermore, as a method of measuring the critical current distribution, for example, the superconductive wire 1 may be divided into a plurality of slits in the width direction, and the critical current may be measured for each slit of the wire. Although any method may be used as a method of measuring the critical current, for example, a four-terminal method may be used.

(Method of Measuring Thickness of Superconductive Layer in Superconductive Wire)

In the superconductive wire 1 illustrated in FIG. 1, the thickness of the superconductive layer 11 differs between the central portion 20 and the end portion 21. For example, the thickness t1 and the thickness t2 of the superconductive layer 11 may be measured as follows. Specifically, the superconductive wire 1 is cut along the width direction so as to observe its cross section. For example, the cross-section of the superconductive wire 1 may be photographed, and the thickness of the superconductive layer 11 may be measured from the photograph. As a measurement method, the thickness of the superconductive layer 11 is measured at several arbitrary places in each of the central portion 20 and the end portion 21, for example, at 5 places including the center of each portion that are spaced with equal intervals. The average value of the measured data for each of the central portion 20 and the end portion 21 may be calculated as the thicknesses t1 of the central portion 20 and the thicknesses t2 of the end portion 21, respectively.

(Method of Manufacturing Superconductive Wire)

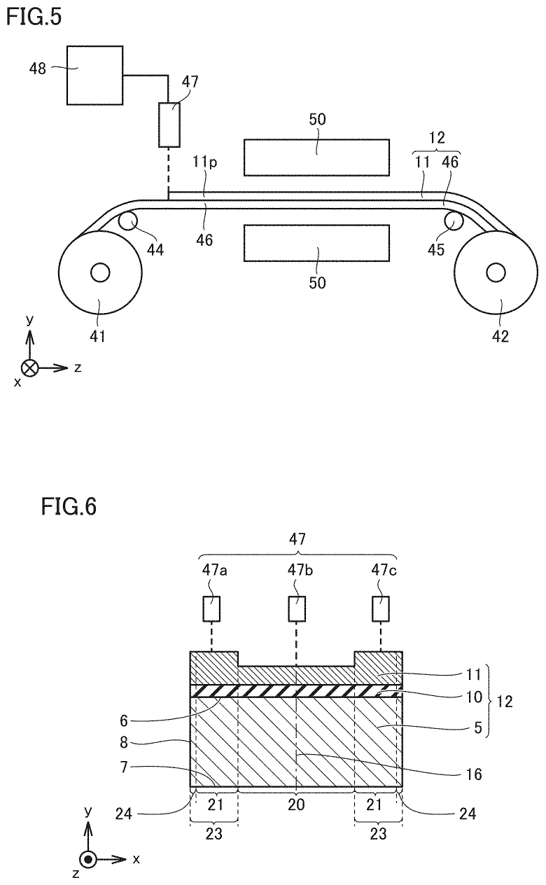

FIGS. 5 and 6 are schematic views for explaining a method of manufacturing a superconductive wire according to the present embodiment. Hereinafter, the manufacturing method of the superconductive wire 1 according to the present embodiment will be described with reference to FIGS. 5 and 6. The superconductive wire 1 may be manufactured by any manufacturing method. For example, the method of manufacturing the superconductive wire 1 includes a substrate preparation step (S100), an intermediate layer formation step (S200), a superconductive layer formation step (S300), and an enveloping layer formation step (S400).

The step (S100) is a step of preparing the substrate 5. In the step of preparing the substrate 5, the substrate 5 is formed by using any method known in the art. For example, a first layer may be prepared from a tape made of metal such as stainless steel, and a second layer, a third layer and a fourth layer may be sequentially formed on the first layer so as to produce the substrate 5 having a laminated structure. As a method of forming these layers, any method such as plating or sputtering may be used.

The step (S200) is a step of forming the intermediate layer 10. In this step (S200), the intermediate layer 10 is formed on the substrate 5. As a method of forming the intermediate layer 10, any method such as plating or sputtering may be used.

In the step (S300), the superconductive layer 11 is formed on the intermediate layer 10. In this step (S300), the superconductive layer 11 is formed by using any method known in the art. For example, the superconductive layer 11 may be formed by metal organic decomposition (MOD). Specifically, as illustrated in FIGS. 5 and 6, a manufacturing apparatus may be used to coat a raw material solution of the superconductive layer 11 on a tape-shaped member 46 that is formed with the intermediate layer 10 on the first main surface 6 of the substrate 5, and heat the same thereafter to form the superconductive layer. The manufacturing apparatus illustrated in FIGS. 5 and 6 mainly includes a holding device disposed at the inlet side and configured to hold a coil 41 of the tape-shaped member 46, a coating device 47 configured to coat the raw material solution for forming the superconductive layer on the tape-shaped member 46, a heating device 50 configured to heat the raw material solution so as to form the superconductive layer 11, and a winding device disposed at the outlet side and configured to wind the wire member 12 that is formed with the superconductive layer 11 on the intermediate layer 10 of the tape-shaped member 46 into a coil 42.

In the manufacturing apparatus illustrated in FIGS. 5 and 6, the tape-shaped member 46 is unwound from the coil 41 held by the holding device at the inlet side. The unwound tape-shaped member 46 is guided by the guiding roller 44 to a position underneath the coating device 47. As illustrated in FIG. 6, the coating device 47 includes a plurality of coating units 47a to 47c arranged side by side in the width direction of the substrate 5. Specifically, the coating device 47 includes a coating unit 47b configured to coat the raw material solution at least at a position corresponding to the central portion 20 of the superconductive wire, and coating units 47a and 47c configured to coat the raw material solution at a position corresponding to the end portion 21. The coating units 47a and 47c are configured to coat more raw material solution on the tape-shaped member 46 per unit time than the coating unit 47b. As a result, the thickness of the raw material solution coated on the tape-shaped member 46 at the position corresponding to the end portion 21 is thicker than the thickness of the raw material solution coated at the position corresponding to the central portion 20.

Thereafter, the tape-shaped member 46 coated with the raw material solution is guided to the heating device 50 to undergo a heat treatment. The raw material solution is heated by the heating device 50 to form the superconductive layer 11. As described above, since the thickness of the raw material solution coated at the end portion 21 is relatively thick, the thickness t1 of the superconductive layer 11 at the end portion 21 is thicker than the thickness t2 of the superconductive layer 11 at the central portion 20 as illustrated in FIG. 1.

After passing through the heating device 50, the tape-shaped member 46 that is formed with the superconductive layer 11 is guided by a guiding roller 45 to the winding device. The tape-shaped member 46 is wound into the coil 42 by the winding device.

In the above example, the thickness of superconductive layer is adjusted by adjusting the thickness of the raw material solution coated on the central portion 20 and the thickness of the raw material solution coated on the end portion 21. However, the thickness of superconductive layer may be adjusted by adjusting the other factor such as the concentration of the raw material solution. Specifically, the concentration of the raw material solution to be coated by the coating unit 47b may be made lower than the concentration of the raw material solution to be coated by the coating units 47a and 47c. In this manner, it is also possible to make the thickness t2 of the superconductive layer 11 at the central portion 20 thinner than the thickness t1 of the superconductive layer 11 at the end portion 21.

The step (S400) is a step of forming the enveloping layer 13 as an enveloping conductor layer, and includes a step of forming the stabilization layer 14 and a step of forming the protection layer 15. In the step of forming the stabilization layer 14, the stabilization layer 14 is formed at least on the surface of the superconductive layer 11 and the second main surface 7 of the substrate 5 as a first conductor layer. In the step of forming the stabilization layer 14, the stabilization layer 14 may be formed to envelope the entire side surface 8 of the wire member 12. Any method such as sputtering or plating may be used to form the stabilization layer 14.

In the step of forming the protection layer 15, the protection layer 15 may be formed on the stabilization layer 14 by plating, for example. The protection layer 15 may be formed by any method instead of plating. Thus, the superconductive wire illustrated in FIG. 1 may be obtained.

### Second Embodiment

(Configuration of Superconductive Wire)

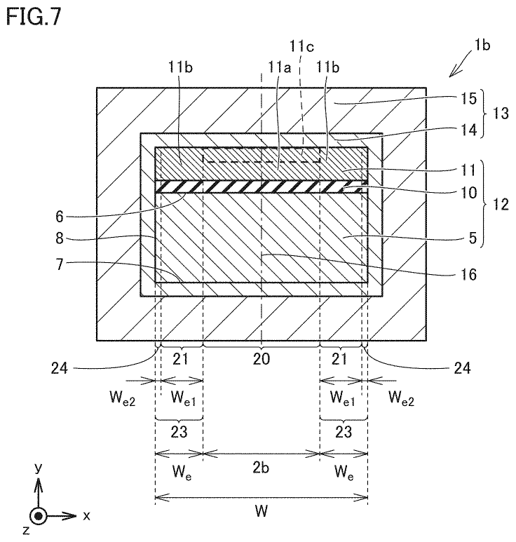

FIG. 7 is a schematic view illustrating a cross section of a superconductive wire according to the present embodiment. As illustrated in FIG. 7, the superconductive wire 1b is basically the same as the superconductive wire 1 illustrated in FIG. 1 but different from the superconductive wire 1 illustrated in FIG. 1 in the configuration of the superconductive layer 11. Specifically, in the superconductive wire 1b, the thickness of the superconductive layer 11 is substantially constant in the width direction of the superconductive wire 1b. The superconductive layer 11a or 11c located at the central portion 20 includes a portion 11c which has a lower crystal orientation than the superconductive layer 11b located at the end portion 21. The portion 11c with a lower orientation may be formed across the entire surface of the central portion 20 or may be formed only at a part of the central portion 20.

(Effect of Superconductive Wire)

In the present embodiment, similar to the superconductive wire 1 illustrated in FIG. 1, the critical current distribution between the central portion 20 and the end portion 21 may be adjusted by adjusting the size and/or the degree of orientation of the portion 11c that has a low crystal orientation in the superconductive layer 11a or 11c located at the central portion 20. As to be described hereinafter, the portion 11c which has a lower crystal orientation may be formed by lowering the heating temperature of a heater in the heat treatment for forming the superconductive layer 11 or turning off the heater for heating the portion 11c, which makes it possible to reduce the manufacturing cost.

The position of the central portion and the position of the end portion in the superconductive wire may be determined in the same manner as the superconductive wire according to the first embodiment described above. Further, the critical current distribution may also be measured by the same method as that of the superconductive wire according to the first embodiment described above.

(Method of Measuring Crystal Orientation in Superconductive Wire)

Although any method may be used as a method of measuring the crystal orientation in the superconductive layer 11 of the superconductive wire 1b, an XRD measurement may be adopted, for example. Specifically, a sample is taken at any position in the longitudinal direction of the superconductive wire 1b. Then, the enveloping layer 13 is removed from the sample by etching or the like so as to expose the superconductive layer 11. The XRD measurement is performed on the exposed superconductive layer 11 at a position corresponding to the central portion 20 and a position corresponding to the end portion 21. Specifically, the crystal orientation of a target position is evaluated from the (005) peak intensity of the superconductive layer 11 observed by θ-2θ measurement. The XRD measurement is performed on the central portion 20 and the end portion 21 for 5 times, and the average value of the obtained data may be used as the crystal orientation.

(Method of Manufacturing Superconductive Wire)

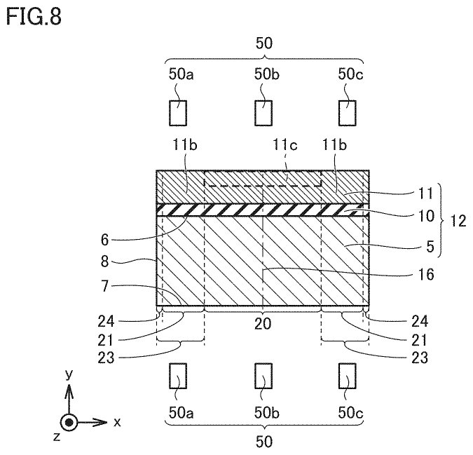

FIG. 8 is a schematic view for explaining a method of manufacturing the superconductive wire illustrated in FIG. 7. The method of manufacturing the superconductive wire 1b illustrated in FIG. 7 is basically the same as the method of manufacturing the superconductive wire 1 illustrated in FIG. 1 but partially different in the step (S300). Specifically, in the method of manufacturing the superconductive wire illustrated in FIG. 7, in the step (S300), the raw material solution of the superconductive layer 11 is coated on the tape-shaped member 46 at a substantially uniform thickness in the width direction (see FIG. 5). Then, in the subsequent heating step, as illustrated in FIG. 8, the raw material solution is heated by a plurality of heating units 50a to 50c arranged side by side in the width direction of the substrate 5 constituting the tape-shaped member 46. During the heating, the heating unit 50b arranged at a position corresponding to the central portion 20 is set to a lower heating temperature than the other heating units 50a and 50c arranged at a position corresponding to the end portion 21. Alternatively, the heating unit 50b may be turned off. The heating units 50a to 50c each may be a heater such as a heating lamp disposed, for example, along the extending direction of the tape-shaped member 46.

As a result, the raw material solution coated on the central portion 20 does not react sufficiently, and thus, a portion 11c with a lower crystal orientation is formed in the superconductive layer 11a. The superconductivity of the portion 11c is inferior to that of the superconductive layer 11b located at the end portion 21. Alternatively, the portion 11c may be formed with no superconductivity.

Except the above-described step, the other steps are performed in the same manner as those in the method of manufacturing the superconductive wire illustrated in FIG. 1. Thus, the superconductive wire 1b illustrated in FIG. 7 is obtained.

### Third Embodiment

(Configuration of Superconductive Coil)

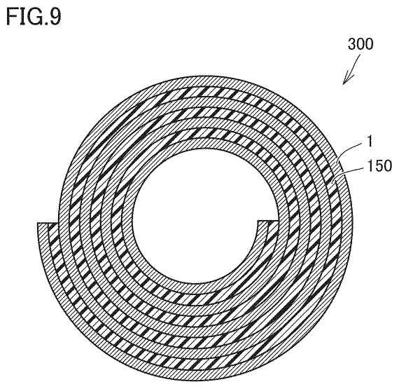

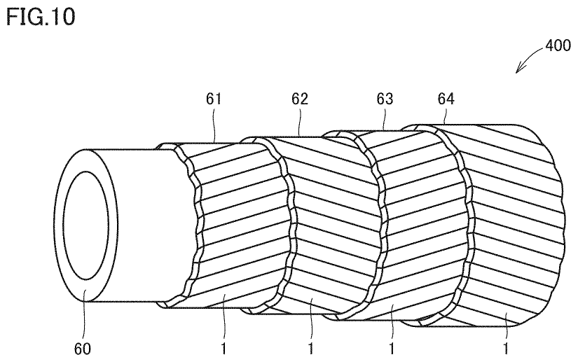

Hereinafter, the configuration of a superconductive coil 300 according to the present embodiment will be described with reference to the drawings. FIG. 9 is a schematic view illustrating a cross section perpendicular to the coil axis of the superconductive coil 300 according to the present embodiment. As illustrated in FIG. 9, the superconductive coil 300 according to the present embodiment includes a superconductive wire 1 and an insulator 150.

The superconductive wire 1 is the same as the superconductive wire 1 according to the first embodiment or the second embodiment described above, and has a spiral shape around a coil axis. In other words, the superconductive wire 1 is wound around the coil axis. The superconductive wire 1 is wound with a space reserved between adjacent turns.

The insulator 150 is filled in the space reserved between adjacent turns of the wound superconductive wire 1. As a result, adjacent turns of the wound superconductive wire 1 are insulated and fixed mutually. In other words, the superconductive wire 1 is sandwiched by the insulator 150.

The insulator 150 may be formed from a thermosetting resin. Preferably, the thermosetting resin used to form the insulator 150 has a small viscosity that makes it possible for it to be impregnated into the space reserved between adjacent turns of the wound superconductive wire 1 before curing. The thermosetting resin used to form the insulator 150 may be epoxy resin, for example.

(Method of Manufacturing Superconductive Coil)

The superconductive coil 300 may be manufactured by any manufacturing method. For example, the superconductive wire 1 is wound around the coil axis, and then the resin for forming the insulator 150 is impregnated into the space reserved between adjacent turns of the wound superconductive wire 1. Thereafter, the resin is subjected to a curing treatment. As the curing treatment, for example, the heat treatment is performed. In addition, electrode terminals (not shown) may be connected to the superconductive wire 1. Thus, the superconductive coil 300 illustrated in FIG. 9 is obtained.

(Effect of Superconductive Coil)

Since the superconductive coil 300 illustrated in FIG. 9 is manufactured by using the superconductive wire 1 obtained with a reduced manufacturing cost, the superconductive coil 300 may be obtained at a lower cost. It should be noted that the superconductive wire 1b illustrated in FIG. 7 may be used to manufacture the superconductive coil 300.

### Fourth Embodiment

(Configuration of Superconductive Cable Conductor)

Hereinafter, the configuration of a superconductive cable conductor 400 according to the present embodiment will be described with reference to the drawings. FIG. 10 is a schematic perspective view illustrating the configuration of the superconductive cable conductor 400 according to the present embodiment. As illustrated in FIG. 10, the superconductive coil 300 according to the present embodiment includes a superconductive wire 1 and a cylindrical coil former 60.

The superconductive wire 1 is the same as the superconductive wire 1 according to the first embodiment or the second embodiment described above. The superconductive wire 1 is spirally wound on the outer peripheral surface of the coil former 60. In FIG. 10, the superconductive cable conductor 400 is formed by spirally winding a plurality of superconductive wires 1 into multiple layers laminated on the outer peripheral surface of the coil former 60. The number of the superconductive wire 1 to be wound on the coil former 60 may be one or more.

As illustrated in FIG. 10, the superconductive wire 1 is wound by alternately switching the winding direction of each layer, i.e., a first layer 61 of the superconductive wire 1 that is located closest to the outer peripheral surface of the coil former 60 is wound clockwise in the figure, a second layer 62 is wound counterclockwise in the figure, a third layer 63 is wound clockwise in the figure, and a fourth layer 64 is wound counterclockwise in the figure. However, the winding direction of the first layer 61 to the fourth layer 64 is not limited to that described above, they may be wound in any direction. For example, the first layer 61 and the second layer 62 may be wound clockwise in the figure, and the third layer 63 and the fourth layer 64 may be wound counterclockwise in the figure, or all of the first to fourth layers 61 to 64 may be wound in the same direction. A protection layer may be formed to surround the outer periphery of the superconductive wire 1. The protection layer may be formed from any insulating material such as resin.

(Method of Manufacturing Superconductive Cable Conductor)

The superconductive cable conductor 400 may be manufactured by any manufacturing method. For example, the superconductive wire 1 is spirally wound on the outer peripheral surface of coil former 60, and then the superconductive wire 1 is fixed relative to the coil former 60. In addition, electrode terminals or the like may be connected to the superconductive wire 1. Thus, the superconductive cable conductor 400 illustrated in FIG. 10 is obtained.

(Effect of Superconductive Cable Conductor)

Since the superconductive cable conductor 400 illustrated in FIG. 10 is manufactured by using the superconductive wire 1 obtained with a reduced manufacturing cost, the superconductive cable conductor 400 may be obtained at a lower cost. It should be noted that the superconductive wire 1b illustrated in FIG. 7 may be used to manufacture the superconductive cable conductor 400.

It should be understood that the embodiments disclosed herein have been presented for the purpose of illustration and description but not limited in all aspects. It is intended that the scope of the present invention is not limited to the description above but defined by the scope of the claims and encompasses all modifications equivalent in meaning and scope to the claims.

### REFERENCE SIGNS LIST

1, 1b: superconductive wire; 5: substrate; 6: first main surface; 7: second main surface; 8: side surface; 10: intermediate layer; 11, 11a, 11b: superconductive layer; 11c: portion; 12: wire member; 13: enveloping layer; 14: stabilization layer; 15: protection layer; 16: center; 20: central portion; 21: end portion; 23: outer peripheral portion; 24: edge; 30: detection sensor; 33, 34, 35: current; 41, 42: coil; 44, 45: guiding roller; 46: tape-shaped member; 47: coating device; 47a, 47b, 47c: coating unit; 50: heating device; 50a, 50b, 50c: heating unit; 60: coil former; 61: first layer; 62: second layer; 63: third layer; 64: fourth layer; 150: insulator; 300: superconductive coil; 400: superconductive cable conductor

1. A superconductive wire comprising:
a tape-shaped substrate having a main surface; and
a superconductive layer provided on the main surface,
a critical current flowing through an end portion in a width direction perpendicular to the extending direction of the substrate being larger than a critical current flowing through a central portion in the width direction.

2. The superconductive wire according to claim 1, wherein
when the distance from the center of the substrate in the width direction to an end surface of the substrate is expressed by a (unit: mm), the central portion is a region with a distance of 0.6a or less from the center, and the end portion is a region with a distance greater than 0.6a and equal to or less than (a−0.1) from the center,
the critical current flowing through the end portion is 1.1 times or more and 2.5 times or less as large as the critical current flowing through the central portion.

3. The superconductive wire according to claim 1, wherein
the superconductive layer located at the central portion includes a portion which has a thickness thinner than the thickness of the superconductive layer located at the end portion.

4. The superconductive wire according to claim 1, wherein
the superconductive layer located at the central portion includes a portion which has a lower crystal orientation than the superconductive wire located in the end portion.

5. A superconductive coil comprising:
the superconductive wire according to claim 1; and
an insulator,
the superconductive wire being wound into a spiral shape with a space reserved between adjacent turns, and
the insulator being filled in the space.

6. A superconductive cable conductor comprising the superconductive wire according to claim 1.
